(19) United States
(12) Patent Application Publication
(10) Pub. No.: US 2008/0126533 A1
(43) Pub. Date: May 29, 2008

(54) FEEDBACK BASED ACCESS AND CONTROL OF FEDERATED SENSORS

(75) Inventors: Johannes Klein, Redmond, WA (US); Ruston John David Panabaker, Bellevue, WA (US); Eric Horvitz, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/557,071

(22) Filed: Nov. 6, 2006

(51) Int. Cl. G06F 15/173; G08B 13/00

(52) U.S. Cl. 709/224; 340/541

(57) ABSTRACT

A method and system is provided for managing or controlling a network of federated devices. In one example, the devices in the network capture data corresponding to an object or entity of interest. The captured data is sent to a server component such as a hub or backend processor which further processes the data. Based on the received data, the hub or backend processor generates commands or instructions for the network or devices in the network. The commands/instructions are sent to the network to modify network behavior or to controlling device behavior.

### BACKGROUND

Networks of sensing devices have been used for a variety of surveillance or detection purposes. Sensors are typically positioned in fixed positions within an environment for detection of conditions of interest in the environment. As an example, sensors may be positioned in a building or structure, such as a private home, for detecting the presence of intruders. When an intruder enters the building, an image of the intruder may be captured for later identification. Sensors may also detect the presence of the intruder by other means such as sound, vibration, pressure (e.g., pressure exerted on sensors in the floor), etc.

However, overall operation of sensing devices in a sensor network may not be controlled remotely based on data returned from the sensor network. Hence, sensor networks are typically limited in providing desired data corresponding to an object or condition of interest to be monitored in a sensor network.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a system controls a federated network of devices. The system may include a collection unit that receives data from the network of devices and an attention model unit for processing the received data from the network of devices. A feedback unit generates instructions for controlling the network of devices. The instructions are generated based on the data received from the devices in the network.

Also, a method for controlling a federated network of devices is provided. Data corresponding to an entity of interest is received and a feedback control message is generated based on the received data corresponding to the entity of interest.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a partial block diagram illustrating a network of federated devices.

FIGS. 2A-2C illustrate an example of federated devices in a network coalescing around an object.

FIG. 3 is a partial block diagram illustrating an example of a server component or hub for providing feedback instructions to a federated network.

FIG. 4 is a partial block diagram illustrating an example of an attention modeling unit.

FIG. 5 illustrates another example of an attention modeling unit receiving multiple input from devices in a federated network.

FIG. 6 is a flowchart illustrating an example of a method for controlling a sensor network via feedback control.

FIG. 7 is a flowchart illustrating an example of a method for analyzing data from devices in a federated network.

FIG. 8 is a flowchart illustrating another method of feedback control of sensing devices.

FIG. 9 illustrates an example of generating a synthesized image from multiple images.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

A method and system for controlling a network of federated devices is described. In one example, the federated devices include sensing devices in a sensor network that detect and report information of interest. The information reported from the devices is further processed in a server, hub, central processor or other remote device. Based on the information received from the sensor devices in the network, the server or remote device may further configure or control the sensor devices in the network. Hence, in this example, feedback from the devices in the network may be used in a remote device, server or hub to further control or organize the devices.

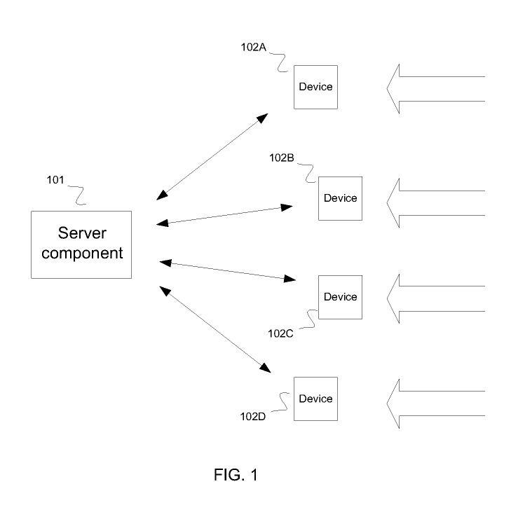

FIG. 1 is a partial block diagram illustrating an example of a network of federated devices in a sensor network. A service component 101 may communicate with any of the devices in the network. As illustrated in FIG. 1, a network may include device 102A, 102B, 102C and 102D. Although FIG. 1 illustrates four devices in the federated network, any number of devices may be included in the network. Any of the devices may transmit data to the server component 101 where the data may be further manipulated or processed.

In one example, the devices 102A, 102B, 102C or 102D are camera sensors which transmit images of an environment to the server component 101. The server component 101 may be a hub or backend processor that receives the image information from the camera sensors. Based on the received images at the server component 101, an object or entity of interest may be detected. The server component 101 may further generate instructions based on the received images and may transmit the instructions to any of the devices 102A, 102B, 102C or 102D. The instructions may include, for example, instructions for controlling or informing network behavior for the devices or controlling device behavior. Hence, in this example, the server component 101 provides feedback control of the federated devices 102A, 102B, 102C, and 102D in the federated network based on data generated and received from the devices.

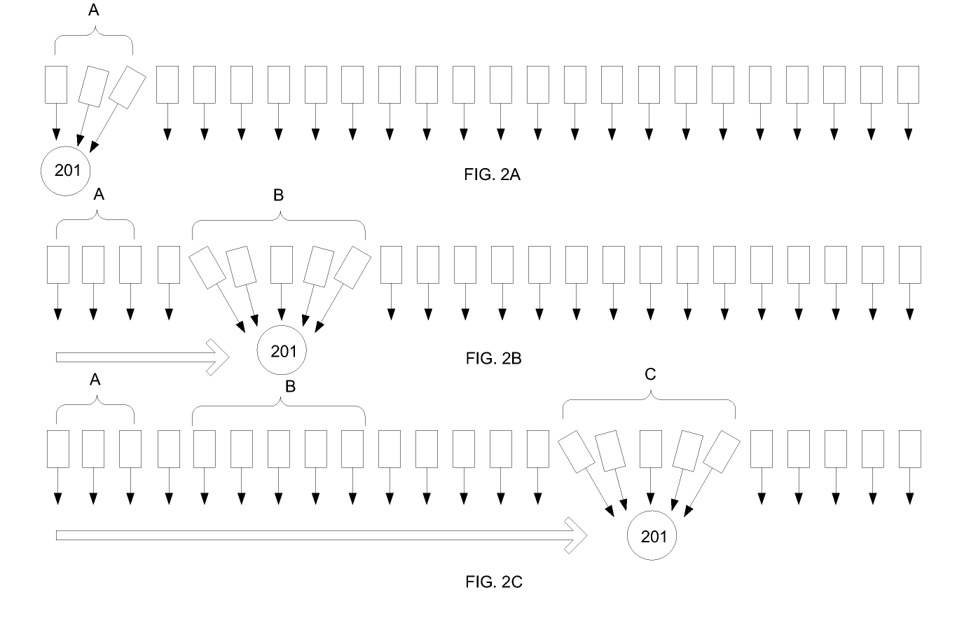

The feedback information from the server component 101 may be used to aggregate or coalesce devices around an object, entity or event of interest. FIGS. 2A-2C illustrate an example of federated devices in a network (e.g., sensor network) coalescing around an object. When the devices coalesce around an object or event, the devices in the vicinity of the object or event are activated and focus on the object or event to detect the object or event. As the object moves through the environment, the object or event moves away from certain devices and toward other devices. When the object or event moves a predetermined distance away from a device, the device discontinues providing information on the object (i.e., the device no longer focuses on the object or event). As the object moves within a predetermined distance of other devices, the other devices may then coalesce around (or focus on) the object or event and provide information (e.g., image, audio, vibration data, etc.) corresponding to the object or event to a remote device such as a hub or backend processor. Hence, the object may be detected and characteristics and qualities (including location information) of the object or event may be received at the hub or backend processor (e.g., the service component 101).

In this example, the object 201 is detected at a location within an environment. The devices included in group A (FIG. 2A) coalesce around the object 201 by focusing on the object 201. The coalescence of the devices in Group A around the object 201 is depicted in FIG. 2A as the devices in Group A orienting or pointing toward the object 201. Devices in the network that are greater than a predetermined distance from the object 201 (i.e., devices that are not in Group A) do not coalesce around the object 201. The devices in the federated network that are greater than a predetermined distance from the object 201 do not coalesce around the object 201 (i.e., do not focus on the object 201 or orient/point toward the object 201).

FIG. 2B shows the federated network of sensing devices of FIG. 2A after the object 201 has moved. As FIG. 2B illustrates, the object 201 has moved beyond a predetermined distance from the devices in Group A and has moved within a predetermined distance of devices in Group B. Hence, the devices in Group A no longer coalesce around (or orient toward) the object 201. Instead, the devices in Group B coalesce around the object 201 by focusing on and pointing toward the object 201.

FIG. 2C shows the federated network of sensing devices of FIGS. 2A and 2B after the object 201 has moved away from the devices of Group A and Group B. In this example, the object 201 has moved to a location in the federated network that is greater than a predetermined distance from the devices of Group A and the devices of Group B. However, the object 201 has moved to within a predetermined distance of devices of Group C. Hence, in this example, the devices in Group C coalesce around the object 201 by focusing or pointing toward the object 201. Also, the devices in both Group A and Group B, being greater than a predetermined distance from the object 201, no longer coalesce around the object 201. Thus, in this example, a “coalescence” of devices may “follow” an object or event as the object or event moves within a field or environment as a “roving eyeball cloud” that “sees” (i.e., detects) the object of interest and follows the movements of the object. The network of devices may further adapt and re-configure to follow the object based on instructions received from a remote device such as a hub or server. The instructions received from the remote device may, in turn, be based on images or other data generated by the devices in the network themselves. Further, the devices may terminate tracking of the device when the object is no longer detected by the devices (e.g., object is out of range).

In yet another example, multiple devices may be used for controlling the network. Data may be collected from at least one federated device in a network and returned to multiple devices in which the multiple devices are capable of controlling at least one of the federated devices in the network based on the returned data from the at least one federated device in the network. The multiple devices for controlling the federated devices in the network may include any combination of devices such as a server, hub, federated device, etc. Each of the multiple devices may control the network based on a variety of factors including, for example, a condition preference or a priority. For example, a condition preference of devices may be provided such that when feedback data is received from federated devices in the network, a set of condition preference rules may be accessed in order to determine which of the multiple devices to control the devices in the network based on the feedback. The set of condition preference rules may be previously stored in the device or may be entered in real-time by a user. Alternatively, the set of condition preference rules may be included by a manufacturer of the device of by a service provider.

Also, the determination of a device to control the devices in the network may be based on a system or policy of priorities. Each of the devices (e.g., server, hub, etc.) for controlling the federated devices in the network may have a corresponding priority such that a device with a higher priority may be selected for controlling devices in the network over a device with a lower priority. Information such as sensor data collected by devices in the network may be returned to the devices (server, hub, etc.) for controlling the devices and, based on the relative priority values of the servers/hubs, a server/hub may be selected to control the devices in the network based on the information received. As one example, a face detection module may operate on a server as one device for receiving data from devices in the network. The face detection module may detect a human operator as using the network and may assign a high priority to the human operator. Hence, the human operator may control the network devices even though at least one other device may be available (but with a lower priority) to control the devices. For example, a second device or server for receiving data from the network devices and controlling the network devices accordingly may also be present; however, the lower priority device may not control the device if the human operator is detected. Control of the network devices in this example is provided by the human operator (with higher priority) based on feedback from the network devices themselves.

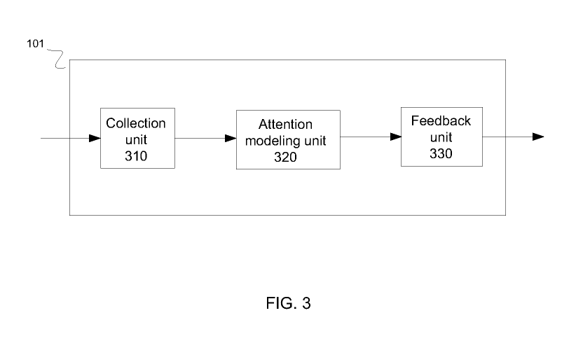

FIG. 3 is a partial block diagram illustrating an example of a server component or hub for providing feedback instructions to a federated network. The server component 101 illustrated in FIG. 3 receives data from at least one device. A collection unit 310 in the server component 101 receives the data from the federated devices (e.g., sensing devices) for detection or characterization of an object or entity of interest.

The data received from the devices in the network may include any type of data for identifying or detecting an object, event, entity or other environmental information. For example, the devices may include camera or video devices for obtaining still photo or motion video of the environment or object/entity within the environment. The devices may also include acoustic devices for obtaining sound/audio data of objects, events, etc. in the environment or a thermostat for obtaining temperature data, seismic sensors for obtaining vibration data, heat/cold sensors, pressure sensors for obtaining pressure information, infrared detectors, particulate matter detectors for detecting the presence of airborne particles, chemicals or fumes, or any other device capable of detecting desired information.

The data received from the devices via the collection unit 310 is further processed in the Attention Modeling Unit 320. The Attention Modeling Unit 320 analyzes the information to determine the presence and/or the characteristics of the object, event or entity of interest within the network. Based on the information received, the Attention Modeling Unit 320 generates instructions and sends the instructions to the feedback unit 330 to further control or inform the network of devices. As one example, the collection unit 310 may receive information from federated devices in a sensor network indicating the presence and/or location of an object of interest. The Attention Modeling Unit 320 generates instructions based on the presence and location of the object of interest to the feedback unit 330 to transmit a command or instruction to the devices in the vicinity of the object of interest to activate and coalesce around the object of interest. The command/instruction is transmitted from the service component 101 via the feedback unit 330 to the corresponding devices to re-configure the devices in the network, if necessary, to provide further data pertaining to the object of interest.

The feedback unit 330 may generate and send instructions to the devices for any type of desired device behavior. For example, the feedback unit 330 may generate instructions to control sensing behavior such as directing sensors to orient themselves toward a detected object, activating a subset of sensors, deactivating a subset of sensors, increasing or decreasing the length of a sleep cycle of a subset of sensors, increasing or decreasing sampling frequency of a subset of devices, etc.

Alternatively, the feedback unit 330 may generate instructions for controlling or informing networking behavior in the network. For example, the server component 101 may determine points of interest within the environment of the network. The network may receive information pertaining to points of interest from the server component 101 and, based on the received information, the network may modify routing of data within the network. As one example, the network may assign priority to devices in the network based on the received information from the server component 101 such as assigning higher priority to devices in the vicinity of the point of interest.

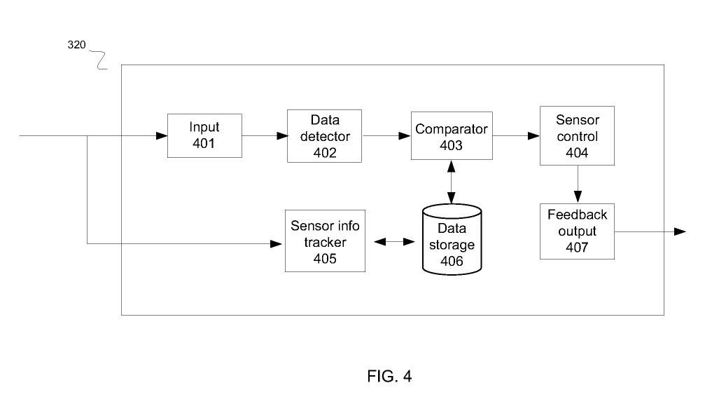

FIG. 4 is a partial block diagram illustrating an example of the attention modeling unit 320 of a server component 101. The attention modeling unit 320 of FIG. 4 includes an input 401 for receiving device data or data corresponding to an object or entity of interest from the collection unit. For example, location information of the devices in the federated network may be received at the sensor information tracker 405 which may further be stored in data storage 406. The location information may be received periodically and updated in the data storage 406 as the devices change location. Alternatively, the service component 101 may poll the devices periodically to receive location update information which may further be stored in data storage 406.

Also, the data received at the input 401 may include information corresponding to an object or entity of interest. This data may be transmitted from devices in the federated network and may include, for example, location of the object or entity. In this example, the location of the object or entity of interest is received at the input 401 and sent via the data detector 402 to the comparator 403. The comparator 403 accesses the data storage 406 to receive stored information from data storage 406 indicating the location of devices for capturing the data. The comparator 403 compares the location of the object or entity of interest to the location of the devices in the network and identifies devices in the vicinity of the object or entity of interest. The devices identified as being in the vicinity of the object or entity of interest and capable of obtaining data of the object or entity of interest are provided with instructions for obtaining the desired data. In this example, a sensor control 404 generates a control command based on the device and object location information received from the comparator 403. The sensor control 404 provides instructions to the feedback output 407 to transmit instructions to the devices in the network. The instructions to the devices in the network may cause at least a subset of the devices to obtain the desired data.

In one example, the sensor control 404 instructs the feedback output 407 to control device behavior such as orienting at least a subset of the devices to point toward the object or entity of interest. The devices receive the instruction and responsive to the instruction, orient themselves in the specified direction to obtain data associated with the object or entity of interest. Any instruction may be transmitted to the corresponding devices in the network to obtain the desired information. For example, the feedback output 407, responsive to input from the sensor control 404 may also control the devices so that at least a subset of devices are activated or deactivated or increase or decrease the length of a sleep cycle of at least a portion of devices, or increasing or decreasing the sampling frequency.

In addition, the feedback output 407 may provide further instructions for prioritizing the devices in the network. For example, devices identified as being either in the vicinity of the object or entity of interest may be assigned a high priority in the network. Likewise, devices at a location at a special vantage point from the object or entity of interest may be assigned a higher priority than other devices. Priority values of devices may be stored in data storage 406 and compared in comparator 403. Based on the comparison of priority values of corresponding devices in the federated network, the sensor control 404 and feedback output 407 may instruct high priority devices to inform the sensor network. For example, the sensor control 404 and feedback output 407 may instruct selected devices to orient toward the detected object or may activate or deactivate certain devices. Modifications of the devices may be performed based on characteristics of the devices, location of the devices, capabilities of the devices, etc. Such modifications may further include, for example, changing of a sampling frequency or changes in sleep cycle of the devices.

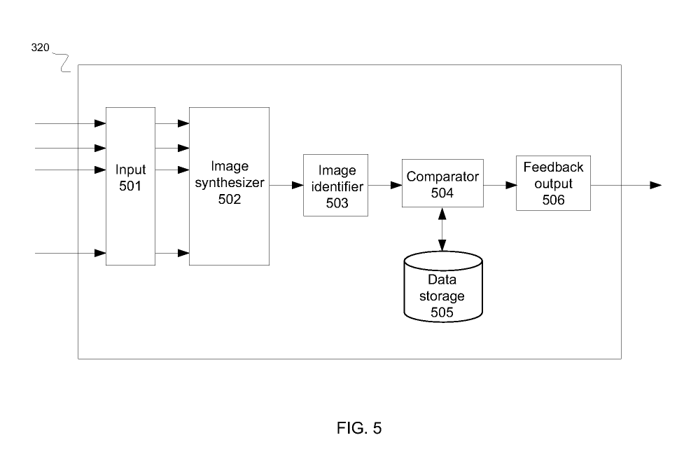

FIG. 5 illustrates another example of the attention modeling unit 320 in which the attention modeling unit 320 receives multiple input from different devices in a federated network such as a sensor network. The attention modeling unit 320 in this example includes an input 501 that receives data from the multiple devices in the network. The input from the devices may be any type of data input corresponding to an object or entity of interest. In one example, the input includes images of an object of interest in which the different images each includes a portion of the subject matter or object of interest or a different aspect of the subject matter. For example, a first device in the network may return an image of one side of an object of interest while a second device in the network may return an image of another side of the object. Any number of devices may provide any number of images of different components or portions of the object.

Each of the received images of the object of interest is transmitted to the image synthesizer 502 of the attention modeling unit 320. The image synthesizer 502 assembles the received images together to create a synthesized image of the object of interest. The synthesized image may be, for example, a panoramic image, intensity field, or a 3-dimensional image of the subject matter.

The attention modeling unit 320 of FIG. 5 further includes an image identifier 503 for identifying the synthesized image. Based on analysis of the image identifier 503, the attention modeling unit 320 identifies the image or object of interest received in the images from the devices. In one example, the image identifier 503 may identify the image by comparing the synthesized image with a reference image stored in data storage 505. In this example, a comparator 504 may access data storage 505 and receive from data storage 505 data corresponding to an image of an object of interest. The image from data storage 505 may be compared with the synthesized image in the comparator 504 for determining characteristics and identifying the object of interest received via input 501. Based on the comparison, a feedback output 506 controls the network accordingly.

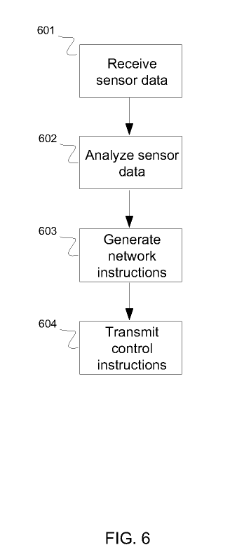

FIG. 6 is a flowchart illustrating an example of a method for controlling a sensor network via feedback control. For example, a sensor network may include imaging devices that may capture image data of an object of interest. The images from the imaging devices may be sent to a hub or backend processor that may further process the images received from the devices. Based on the images received from the devices, the hub or backend processor may generate commands or instructions to control or inform the devices in the network. Alternatively, the hub or backend processor may generate data to inform the network of devices or reconfigure the network. The hub or backend processor sends the command or instructions to the network or to a device or group of devices in the network. The devices in the network receive the command or instructions from the hub which may result in modifications to the network as described herein.

In STEP 601, information from sensor devices in a sensor network is received at a hub or backend processor. The hub may include a collection unit for receiving the data from the sensor devices. The data received may include any information for characterizing an object, entity, event of interest or an environment. For example, the data may include temperature data of an environment being monitored by the sensor network, audio information (e.g., conferences, speeches, etc.), pressure data (e.g., identifying the presence of an individual at a particular location), motion data (e.g., motion detectors in the sensor network), or image data to name a few.

The data received from the devices is further analyzed in STEP 602 to determine the presence of the object of interest at the designated location. Also, the received data may be analyzed to determine characteristics or capabilities of the object, if desired. In this example, the hub may include an attention modeling unit that analyzes the received data to identify the data. For example, the devices in the network may send image data of an object of interest at a location covered by the network. The images of the object may further be stitched together, if desired, to create a synthesized image such as a panoramic image or 3-D image of the object. The attention modeling unit may further compare the images or the synthesized image with image data stored in memory. Based on the comparison (or other analysis), the object of interest may be identified, localized and/or further characterized.

In one example, the devices in the sensor network may be mobile devices. The location of the individual devices in the network may be obtained from the devices. For example, the hub may include a device tracker for locating each device in the network. The location information of the devices may further be stored in storage at the hub or may be stored remotely. When an object is located in the network, the location of the object is compared to the location of each of the devices to determine at least one device capable of providing desired data pertaining to the object. Location of the devices may be retrieved from data storage and compared to the location of the object of interest. Devices in the vicinity of the object (i.e., location information of a device is within a predetermined distance of the location of the object) may be selected as devices capable of providing the desired data. Also, devices having certain characteristics (e.g., having a camera or recording device or in a special vantage point for obtaining images of the object) may also be selected based on the characteristics to provide the desired information.

Based on the information of the object obtained, the hub generates network instructions (STEP 603). In this example, the hub determines that the object of interest is present at the network location. Also, the hub may determine additional relevant characteristics of the object. Based on the information on the object, the hub generates instructions to the network to re-configure or modify the network or any of the devices in the network responsive to the data received from the devices. The instructions are transmitted to the network, a device in the network or a group of devices in the network (STEP 604). Based on the instructions from the hub, the network or devices in the network may be modified. In one example, the instructions control or inform networking behavior in the network such as indicating a point of interest in an area covered by the network and assigning priority to certain devices based on the point of interest (e.g., location of the point of interest relative to location of devices in the network). Routing of data may be modified based on the assigned priority of the devices (e.g., high priority devices may have preference in receiving routed data in the modified network).

In another example, the instructions from the hub control sensing behavior of the devices in the network. In this example, sensing devices in the vicinity of the object may be instructed to re-orient to point toward the object or to become activated to obtain additional image data of the object. Other devices that are determined to be out of range of the object (e.g., located a distance greater than a predetermined distance from the object or located in a position without a view of the object) may be instructed to power off or enter sleep mode. Devices that are in sleep mode that are out of range of the object may be instructed to increase the length of sleep mode and remain in sleep mode. Devices that are in sleep mode that are within range of the object or are in a special vantage point location of the object may be instructed to decrease sleep mode to enter an active mode. These devices may further capture further images of the object in active mode. The devices may further be authorized by feedback instructions from the hub to return to sleep mode after a certain number of images are obtained, after a certain quality of images are obtained, or a certain quota of particular images are obtained, etc. Any criteria may be used to determine if a device should enter sleep mode. Also, the devices may modify their sampling frequency based on feedback instructions from the hub.

In another example, a network of federated devices may include at least one device that does not provide feedback for further control or configuration of the network. As one example, the network of federated devices may include a light, camera, or any other device that may be controlled by another device, hub, server of any other control device. As described, federated devices in the network may provide information obtained via sensing a characteristic of an environment or an object/entity in an environment and may provide the sensed information to a device, server or hub, for example, as feedback. The server, hub or other remote device may control the federated devices based on the feedback as described. In this example, however, the server/hub may also control a federated device in the network that does not provide feedback or any component of the feedback to the server/hub such as a light or camera. For example, the server/hub may control a light (i.e., a federated device in the network) to orient the light toward an object or entity in the network that is sensed by other federated devices in the network. Thus, an object may be detected in an environment in this example, and a server or hub may direct a spot light on the object to illuminate the object. Hence, certain federated devices may provide feedback to a server/hub/etc. such that the server/hub may control (based on the feedback) at least one federated device in the network that does not provide the feedback to the server/hub.

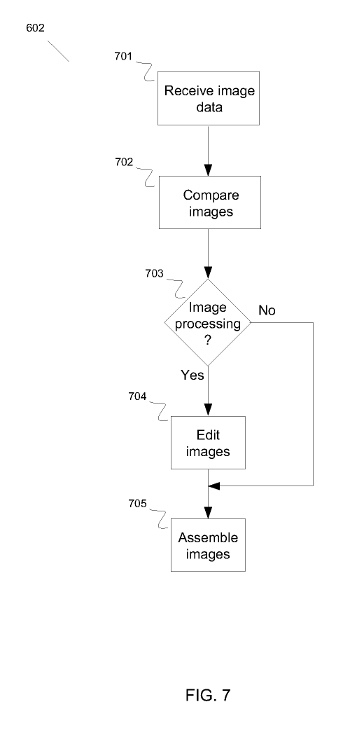

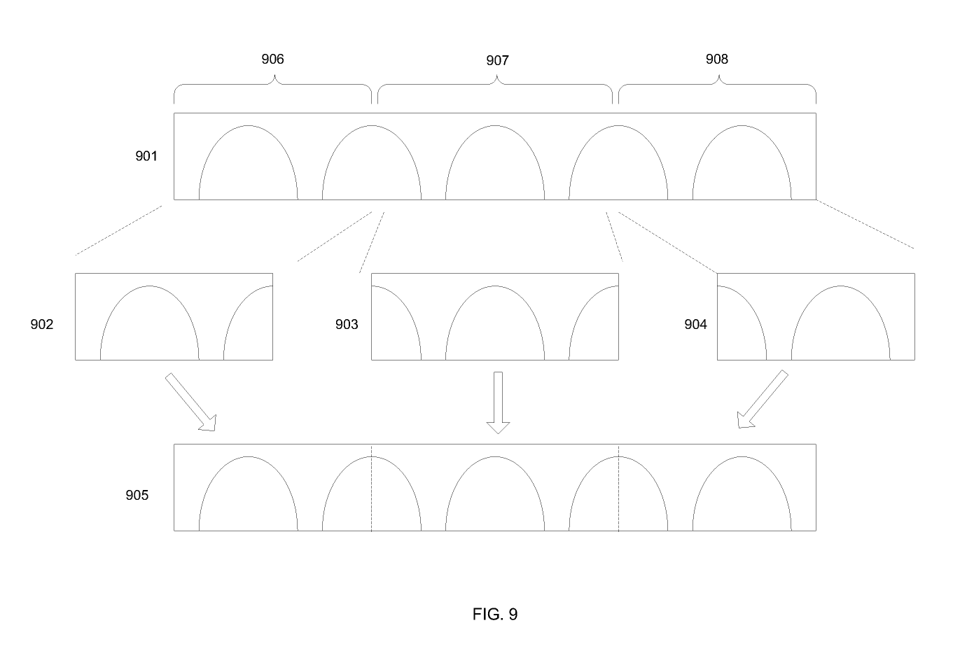

FIG. 7 is a flowchart illustrating an example of a method for analyzing data from devices in a federated network. FIG. 9 illustrates an example of generating a synthesized image from multiple images. In this example, image data is received from sensing devices in a federated network (STEP 701) capable of providing image information of an object or entity of interest. The images may include different images from different devices such that at least one of the images depict a first portion of the object or entity of interest and at least one of the images depict a second portion of the object. FIG. 9 illustrates an example of processing multiple images. As FIG. 9 illustrates, a first device captures an image 902 of a first portion 906 of the object 901, a second device captures an image 903 of a second portion 907 of the object 901 adjacent to the first portion 906, and a third device captures an image 904 of a third portion 908 of the object 901 adjacent to the second portion 907. For illustration purposes, three images are described although any number of images and any number of devices may be used.

The hub receives the images 902, 903, 904 from the devices and compares the images (STEP 702). In this example, the three images (one each for the first, second and third devices) are received and compared. The hub determines that the three images 902, 903, 904 are adjacent to each other via image analysis and also determines if further processing of the images is desired (STEP 703). For example, if the first image 902 and second image 903 are taken at substantially the same exposure but the third image 904 is taken at a higher exposure, the hub may edit the third image 904 to decrease the exposure to match the exposure of the first and second images (“YES” branch of STEP 704).

After the images are edited to conform or if no image processing is desired, the images 902, 903, 904 may be assembled (STEP 705). In this example, the first image 902 depicts a first portion 906 of the object 901 of interest and the second image 903 depicts a second portion 907 of the object 901 of interest that is adjacent to the first portion 906 of the object 901 of interest. Hence, the first image 902 and the second image 903 may be connected or stitched to together in STEP 705 to create a synthesized image of the object 901 in which both the first and second portions (906, 907) of the object 901 are depicted. Similarly, the third image 904 depicts a third portion 908 of the object 901 of interest that is adjacent to the second portion 907 of the object 901. Thus, the third image 904 may be connected to or stitched together with the first and second images (902, 903) to create the synthesized image 905 of the object 901.

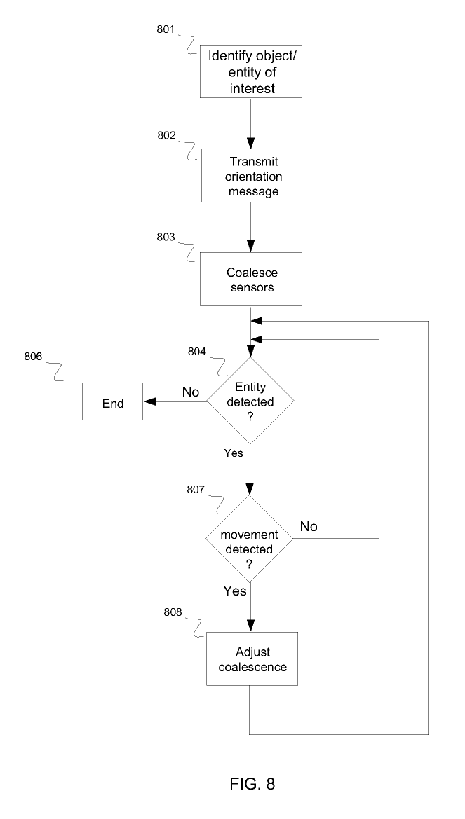

FIG. 8 is a flowchart illustrating another method of feedback control of sensing devices. In STEP 801, an object or entity of interest is detected by the sensing devices. The devices may further indicate the location, orientation or other characteristics of the object. The object information is received at a hub or server device which may be further processed and analyzed at the hub or server to provide further instructions to the network of sensing devices or any subset of sensing devices. The hub or server thus generates commands or instructions for the network or sensing devices based on the information received from the sensing devices.

In STEP 802, the hub or server transmits an orientation message to the network or the sensing devices in the network. The orientation message is based on the information received from the devices in the network. For example, the devices in the network may sense the presence of the object of interest and may transmit images of the object to the hub or server. The hub or server may further identify the object and locate the object within the network using the received data (e.g., images) from the devices in the network. The hub/server in this example then transmits an orientation message to devices in the vicinity of the object of interest to orient themselves toward the object of interest. Also, the hub/server may transmit additional messages to the network or devices in the network. For example, the hub/server may assign priority values to each of the devices in the network based on the information received at the hub/server from the devices in the network. Based on the priority values, certain devices in the network (e.g., devices with high priority values) may be selected from certain functions. In this example, devices with high priority values may be selected to obtain image data of the object of interest.

The selected devices may coalesce into a group of sensing devices for obtaining images of the object of interest (STEP 803). For example, devices in the network that are in the vicinity of the object may be selected by the hub or server to provide images of the object. Based on the images received from the devices in the network, the hub or server may identify the object and may further locate the object within the network. Also, devices in the network in the vicinity of the location of the object may be directed to coalesce or re-organize into a group. In addition, other devices that are in a special vantage point or having certain desired qualities and characteristics may be included in the group.

The selected devices in the group reorganize based on instructions from the hub or server to obtain the desired images. The devices, for example, may orient themselves in the direction of the object or entity of interest. If the object is detected (“YES” branch of STEP 804), then the object is observed and analyzed for movement. Each of the devices may determine a distance to the object of interest and may further determine if the distance changes. The distance between a selected device and the object may increase to a distance greater than a predetermined length. The hub or server receives image data from the device and determines based on the received image data that the device is greater than the predetermined distance from the object. Based on this determination, the hub or server may transmit feedback instructions to the device to discontinue capturing image data of the object. Also, the hub or server may determine that movement of the object has placed the object closer to other unselected devices such that the object is now within a predetermined distance from the unselected devices. Based on this determination, the hub or server may select the unselected devices and transmit a command to the devices to capture image data of the object.

Hence, the coalescence of devices around the object may be adjusted (STEP 808) by the hub or server based on the data received from the devices. When the object is no longer detected by any of the devices (e.g., the object moves out or range) (“NO” branch of STEP 804), then the process terminates.

In another example, a computer-readable medium having computer-executable instructions stored thereon is provided in which execution of the computer-executable instructions performs a method as described above. The computer-readable medium may be included in a system or computer and may include, for example, a hard disk, a magnetic disk, an optical disk, a CD-ROM, etc. A computer-readable medium may also include any type of computer-readable storage media that can store data that is accessible by computer such as random access memories (RAMs), read only memories (ROMs), and the like.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

1. A system for controlling a federated network, the system comprising:
a collection unit for receiving data from the federated network;
an attention model unit for identifying an entity of interest based on the data received from the federated network;
a feedback unit for controlling the network based on the identified entity of interest.

2. The system of claim 1 wherein the data received by the collection unit includes at least one of audio data, temperature data, pressure data, vibration data, environmental data, and image data.

3. The system of claim 2 wherein the data includes a plurality of image data corresponding to the entity of interest, the attention model further stitching together the plurality of image data to generate a synthetic image of the entity of interest.

4. The system of claim 1 wherein the feedback unit transmits instructions to the network based on the identified entity of interest, the instructions performing one of directing devices in the federated network to orient toward the entity of interest, activating at least one of the devices in the federated network, deactivating at least one of the devices in the federated network, modifying the length of a sleep cycle of at least one device in the federated network, and modifying a sampling frequency of at least one device in the federated network.

5. The system of claim 1 wherein the feedback unit generates instructions for controlling or informing networking behavior in the network.

6. The system of claim 5 wherein the feedback unit further transmits a point of interest to the network for modifying routing of data within the network.

7. The system of claim 6 wherein the feedback unit further transmits a priority command to the network for assigning priority to devices in the network.

8. The system of claim 6 wherein the feedback unit further transmits a coalescing command to the network for instructing at least one device in the network to orient toward the entity of interest.

9. The system of claim 6 wherein the modified routing of data within the network is based on the assigned priority of devices in the network.

10. The system of claim 1 wherein the attention modeling unit further receives location information associated with the devices in the network.

11. The system of claim 10 wherein the attention modeling unit determines a location of the entity of interest.

12. The system of claim 11 wherein the feedback unit transmits an instruction to the network based on the location information associated with the devices in the network and the location of the entity of interest.

13. The system of claim 12 wherein the instruction is for modifying a device located within a predetermined distance of the location of the entity of interest.

14. The system of claim 13 wherein the modification of the device includes one of directing the device toward the entity of interest, activating the device, deactivating the device, modifying a sleep cycle of the device, and modifying a sampling frequency of the device.

15. A method of automatically controlling activity in a network, the method comprising:
receiving data from devices in the network, the data corresponding to an entity of interest;
generating a feedback control message based on the received data, the feedback control message for controlling the network.

16. The method of claim 15 further comprising identifying a location of the entity of interest based on the data received from devices in the network.

17. The method of claim 16 wherein the feedback control message modifies a device within a predetermined distance of the entity of interest.

18. The method of claim 17 wherein the modification of the device includes one of positioning the device toward the entity of interest, activating the device, deactivating the device, modifying a sleep cycle of the device, and modifying a sampling frequency of the device.

19. The method of claim 15 wherein the receiving and generating are performed iteratively such that the sensory activity of the network follows movement of the entity of interest within an area covered by the network.

20. The method of claim 15 wherein the data received from the devices comprises a plurality of image data corresponding to at least a portion of the entity of interest, the method further comprising stitching the image data in the plurality of image data together to generate a synthetic image.
